(19) United States
(12) Patent Application Publication
(10) Pub. No.: US 2014/0360945 A1
(43) Pub. Date: Dec. 11, 2014

(54) COMPOSITION AND PROCESS FOR REMOVING IONS

(71) Applicant: Brandon M. Vittur, Houston, TX (US)

(72) Inventor: Brandon M. Vittur, Houston, TX (US)

(73) Assignee: BAKER HUGHES INCORPORATED, Houston, TX (US)

(21) Appl. No.: 13/911,246

(22) Filed: Jun. 6, 2013

(51) Int. Cl. C02F 1/52; C01B 5/00; C02F 1/66

(52) U.S. Cl. CPC C02F 1/52; C02F 1/66; C01B 5/00; C02F 2101/10
USPC 210/724; 210/726; 423/580.1

(57) ABSTRACT

A process for removing polyvalent metal ions from a fluid includes disposing a precipitation composition comprising a precipitating agent in an environment; contacting, with the precipitation composition, a fluid comprising a produced water, a flowback water, or a combination thereof, a plurality of polyvalent metal cations being present in the fluid; forming a plurality of precipitate particles comprising the polyvalent metal cations from the fluid and a polyvalent anion from the precipitating agent; contacting the precipitant particles with a flocculant, a coagulant, or a combination comprising at least one of the foregoing, to form an aggregate comprising the precipitate particles; and separating the aggregate from the fluid to remove the polyvalent metal ions from the fluid. A composition includes a fluid comprising produced water, flowback water, or a combination thereof, a plurality of polyvalent metal cations being present in the fracturing fluid; a precipitation composition comprising a precipitating agent; and a flocculant, a coagulant, or a combination comprising at least one of the foregoing.

### BACKGROUND

Industrial, commercial, and residential use of water typically adulterates the water by addition of contaminating substances. In residential systems, a common adulterant is spent laundry detergent, which contains large amounts of sulfates. In commercial and industrial settings, water is used as a coolant, drainage agent, dilution compound, solvent, and the like. A particular use of water in some commercial environments involves power washing of objects such as sidewalks and buildings. Additionally, even if not involved directly in operations, water can become part of industrial settings as in mining where pools of water collect in shafts, abandoned mine tunnels, open mine strips, and similar features. These pools of water collect vast amounts of minerals and acids. A common issue with each area of use is the accumulation of hard water ions, e.g., divalent alkali metals. Water treatment can be costly and time consuming and does not always reduce contaminants in the water below a level such that the water can be used or to a level for potability.

Water also is used for stimulation of hydrocarbon and natural gas wells as well as in hydraulic fracturing. Various compounds are added to the water before use or retained in the water from subterranean sources, such as by entrainment of dissolved species from a borehole or formation. Some of the chemicals that are found in the water make the water less than ideal for environmental discharge or reuse.

The development of processes and systems that can be used to treat water to decrease various substances in the water is very desirable.

### BRIEF DESCRIPTION

The above and other deficiencies are overcome by, in an embodiment, a process for removing polyvalent metal ions from a fluid, the process comprising: disposing a precipitation composition comprising a precipitating agent in an environment; contacting, with the precipitation composition, a fluid comprising a produced water, a flowback water, or a combination thereof, a plurality of polyvalent metal cations being present in the fluid; forming a plurality of precipitate particles comprising the polyvalent metal cations from the fluid and a polyvalent anion from the precipitating agent; contacting the precipitant particles with a flocculant, a coagulant, or a combination comprising at least one of the foregoing, to form an aggregate comprising the precipitate particles; and separating the aggregate from the fluid to remove the polyvalent metal ions from the fluid.

In a further embodiment, a composition comprises: a fluid comprising produced water, flowback water, or a combination thereof, a plurality of polyvalent metal cations being present in the fracturing fluid; a precipitation composition comprising a precipitating agent; and a flocculant, a coagulant, or a combination comprising at least one of the foregoing.

### DETAILED DESCRIPTION

A detailed description of one or more embodiments is presented herein by way of exemplification and not limitation.

It has been found that a precipitation composition herein precipitates contaminant metal ions in produced water and flowback water, which are recycled as a fracturing fluid. The precipitation and aggregation of the metal ions result in substantial reduction of the metal ions. Further, the amount of metal ions removed from this water is controlled by moderating the amount of certain components in the precipitation composition. As a result, the amount of contaminant metal ions remaining in this water is controllable below a selected level.

In an embodiment, a process for removing polyvalent metal ions from a fluid includes disposing a precipitation composition in an environment. The precipitation composition includes a precipitating agent that contacts a fluid, which includes a produced water, a flowback water, or a combination thereof, and a plurality of polyvalent metal cations is present in the fluid. Due to the contact between the precipitating agent and the fluid, a plurality of precipitate particles is formed such that the precipitate particles include the polyvalent metal cations from the fluid and a polyvalent anion from the precipitating agent. A flocculant, a coagulant, or a combination comprising at least one of the foregoing is added to contact the precipitant particles and to form an aggregate, including the precipitate particles. Thereafter, the aggregate is separated from the fluid to remove the polyvalent metal ions from the fluid.

The fluid (e.g., produced water or flowback water) includes the plurality of the polyvalent metal ions. Produced water typically is water that flows to the surface during production of oil and gas from a subterranean hydrocarbon source. Flowback water, on the other hand, generally is water that flows to the surface after performing a hydraulic fracturing job. Produced water and flowback water contain monovalent and polyvalent metal cations in various amounts and species. Exemplary polyvalent metal cations include aluminum, antimony, arsenic, barium, cadmium, calcium, chromium, cobalt, copper, gallium, germanium, hafnium, indium, iron, lanthanum, lead, magnesium, manganese, mercury, molybdenum, nickel, niobium, radium, selenium, silicon, silver, strontium, sulfur, tantalum, tellurium, thallium, tin, titanium, tungsten, vanadium, zinc, zirconium, or a combination thereof. It is contemplated that the polyvalent metal cations are free and unassociated with a counter ion or other compound in the fluid. However, in an embodiment, the polyvalent metal cations are an ionic species that are hydrated, complexed, combined with another species in the fluid, or a combination thereof.

The polyvalent metal cations are subject to forming a precipitate in response to contact with the precipitating agent in the precipitation composition. The precipitating agent includes polyvalent anions that are, e.g., phosphate metaphosphate, hexametaphosphate, pyrophosphate, hydrogen phosphate, gylcerylphophosphate, phophite, hydrogen phosphite, phosphonate, sulfate, sulfite, thiosulfate, carbonate, citrate, oxalate, adipate, fumarate, glutamate, malate, malonate, tatrate, or a combination thereof.

In an embodiment, the precipitating agent is a compound that provides the polyvalent anions such as a mineral acid, an organic acid, a salt thereof, or a combination thereof, and the like. In some embodiments, the acid (mineral acid or organic acid) is phosphoric acid, sulfuric acid, carbonic acid, citric acid, oxalic acid, adipic acid, fumaric acid, glutamic acid, malic acid, malonic acid, tartaric acid, and the like. Further, the cation of the salts can be a monovalent cation such as, e.g., an alkali metal cation (Na⁺, K⁺, Li⁺, and the like). According to an embodiment, the precipitating agent is the trisodium phosphate, phosphoric acid, a poly or superphosphoric acid (e.g., H₂O₃PO(PO₃H)ₓPO₃H₂), calcium hydroxyapatite (Ca(OH)(PO₄)₃), magnesium phosphate dibasic trihydrate (MgHPO₄.3H₂O), sodium potassium polyphosphate (commercially available under the trade name Polyclear from ICL Performance Products), KH₂PO₄, K₂HPO₄, K₃PO₄, tetrapotassium pyrophosphate (K₄P₂O₇), pentapotassium triphosphate (K₅P₃O₁₀), NaH₂PO₄, Na₂HPO₄, Na₃PO₄, tetrasodium pyrophosphate (Na₄P₂O₇), sodium acid pyrophosphate (Na₂H₂P₂O₇), sodium tripolyphosphate (Na₅P₃O₁₀), sodium hexametaphosphate (Naₙ₊₂PₙO₃ₙ₊₁, n=6, 13, 21, or 28), and the like. In an embodiment, the polyvalent anion is phosphate.

In addition to the precipitating agent, the precipitation composition contains a solvent in some embodiments. The solvent provides an aqueous medium in which to dispose the precipitating agent. To this end, the precipitating agent is highly or partially soluble in the solvent, and the precipitate particles are insoluble or sparingly soluble in the solvent, and more generally in the precipitating agent. Exemplary solvents include water (e.g., distilled water, softened water, low-ion content water, and the like), alcohol (e.g., mono- or poly-hydric alcohols such as methanol, ethanol, isopropanol, a glycol, and the like), ethers, carboxylic acids, ketones, and the like. Polyvalent ions or other ions or species that interfere with the formation of the precipitate particles or decrease the amount the precipitating agent in the precipitation composition are absent in the solvent (and more generally in the precipitation composition) or present in a negligible amount.

The precipitate particles formed from the fluid and the precipitating agent thus depend upon the identity of the polyvalent metal ions in the fluid and the polyvalent anion in the precipitating agent. It is contemplated that common precipitate particles include, e.g., magnesium phosphate, calcium sulfate, barium sulfite, iron (II, III) carbonate, and the like, with the solubility of any particular polyvalent metal ion-polyvalent anion combination depending upon the temperature or pH of the fluid. Consequently, the temperature or pH is set or changed to a selected value to control or selectively precipitate a certain polyvalent metal ion from the fluid as a particular precipitate particle.

The precipitate particles are contacted by the flocculant or coagulant to form the aggregate. In an embodiment, the flocculant or coagulant is a component of the precipitation composition such that when the precipitation composition is introduced into the environment, the flocculant or coagulant therefore is also present. In some embodiments, the flocculant or coagulant is not part of the precipitation composition so that the precipitation composition and flocculant or coagulant are introduced in the container coincidently or asynchronously. Thus, in a particular embodiment, the flocculant or coagulant is added to the environment after formation of the precipitate particles. Without wishing to be bound by theory, it is believed that the flocculant or coagulant accumulates a plurality of precipitate particles to form a large mass of insoluble material with respect to the fluid. In an embodiment, the flocculant bridges precipitate particles, resulting in more efficient settling.

The coagulant is an inorganic salt (e.g., sodium chloride, aluminum sulfate, polyaluminum chloride, ferric sulfate, ferric chloride and sodium aluminate), organic polymer (e.g., polyethyleneimine, dimethylamine-epichlorohydrin copolymer, dicyandiamide-formaldehyde condensation product, cation-modified starch, and the like), tannin, a melamine formaldehyde, a resin amine, or a combination comprising at least one of the foregoing.

The flocculant is a cationic flocculant, a non-ionic flocculant, or an anionic flocculant. Additionally, the flocculant is present as an emulsion, a dispersion, a brine dispersion, and the like. In an embodiment, the flocculant is an emulsion, which includes a copolymer of acrylamide (ACM) and acrylic acid (AA), a copolymer of acrylamide (ACM) and dimethylaminoethyl acrylate (ADAME), N,N-dimethylaminoethyl acrylate methyl chloride quaternary (AETAC, also referred to as Q9), cationic polyacrylamide (EPAM), acrylic acid (AA), ACM, acrylamide (AM), meth acrylic acid (MA), and the like.

According to an embodiment, the flocculant includes an anionic polymer. The anionic polymer includes repeat units that are anionic, cationic, neutral, or a combination thereof such that the polymer has a net negative charge. The repeat units are branched or linear. In an embodiment, the anionic polymer includes repeat units having various anionic functional groups (e.g., carboxylic acid, sulfonic acid, phosphoric acid, or a phosphonic acid functional group, specifically carboxylic acid radicals) alone or together with further polar radicals such as carboxamide radicals. Anionic copolymer flocculants are obtained by copolymerizing an ethylenically unsaturated monomer having an anionic or anionizable side group (e.g., acrylic, methacrylic, vinylsulfonic, vinylphosphonic, itaconic and 2-acrylamidomethylpropanesulfonic acid, sulfopropyl acrylate and sulfopropyl methacrylate) with a nonionic comonomer (e.g., acrylamide, methacrylamide, N-vinylformamide, N-vinylacetamide, N-vinylmethylacetamide, N-vinylmethylformamide, vinyl acetate, vinylpyrrolidone, and the like). Further, anionic functional groups are introduced into the polymer by esterifying carboxyl groups with a polyol, such as ethanediol, and subjecting the remaining free hydroxyl groups to further reaction with, for example, sulfuric acid or phosphoric acid. In an embodiment, the anionic polymer includes acrylamide and acrylic acid prepared by polymerization of acrylamide and acrylic acid or through hydrolysis of polyacrylamide, e.g., partially hydrolyzed polyacrylamide

Exemplary monomer units that are polymerized to form the anionic polymer are acrylamide, (meth)acrylamide, 2-acrylamido-2-methylpropane sulphonic acid, acrylamido propyltrimethyl ammonium chloride, acrylic acid, acrylic acid esters, dimethydiallylammonium chloride, dimethylaminoethyl acrylate, dimethylaminoethyl methacrylate, isopropyl acrylamide, polyethylene glycol methacrylate, itaconic acid, methacrylamido propyltrimethyl ammonium chloride, methacrylic acid, methacrylic acid esters, N-vinyl acetamide, N-vinyl formamide N-vinyl pyrrolidone, N-vinylimidazole, N-vinylpyridine, vinyl sulfonic acid, N,N-dimethylacrylamide, tert-butyl acrylamide, poly(ethylene glycol) methyl ether acrylate, poly(propylene glycol) methyl ether acrylate, poly(ethylene glycol) acrylate, undecanoic acid, lauryl acrylate, (3-acrylamidopropyl)trimethylammonium chloride, N-(hydroxymethyl)acrylamide, N-(hydroxyethyl)acrylamide, 2-acrylamidoglycolic acid, 3-acryloylamino-1-propanol, N-(isobutoxymethyl)acrylamide, N-[Tris(hydroxymethyl)methyl]acrylamide, N-phenylacrylamide, 2-(diethylamino)ethyl acrylate, 2-ethylhexyl acrylate, 2-hydroxyethyl acrylate, 3-(dimethylamino)propyl acrylate, 4-hydroxybutyl acrylate, di(ethylene glycol) 2-ethylhexyl ether acrylate, [2-(acryloyloxy)ethyl]trimethylammonium chloride, sodium acrylate, 2-(diethylamino)ethyl methacrylate, 2-(dimethylamino)ethyl methacrylate, 2-butoxyethyl methacrylate, 3-(acryloyloxy)-2-hydroxypropyl methacrylate, and the like. In a particular embodiment, the anionic polymer is made by copolymerizing (meth)acrylamide and (meth)acrylic acid.

Examples of anionic polymers include polyacrylic acid, polyacrylates, poly((meth) acrylates), acrylamide/sodium acrylate copolymers, acrylamide/sodium (meth) acrylate copolymers, acrylamide/acrylamidomethyl propone sulfonic acid copolymers, terpolymers of acrylamide/acrylamidomethyl propone sulfonic acid/sodium acrylate, and the like. According to an embodiment, the anionic polymer is a copolymer comprising acrylamide and acrylic acid (or an acrylate salt). In an embodiment, the flocculant is a copolymer that includes acrylamide and acrylate repeat units. Such a flocculant copolymer is available under the trade name Spectrafloc 875 from Baker Hughes Inc. or the trade name Tramfloc 100-199 from Tramfloc Inc.

The acrylamide and acrylic acid are present in the polymer in any relative amount. In some embodiments, the acrylamide is present in an amount from 5% to 95% and acrylic acid in an amount from 5% to 95%, based on the total moles of repeat units in the anionic polymer. A ratio of the anionic repeat units to nonionic and cationic repeat units in the anionic copolymer is greater than or equal to 0.1, specifically greater than or equal to 1, more specifically greater than or equal to 10, even more specifically greater than or equal to 100, yet more specifically greater than or equal to 1,000, and further specifically greater than or equal to 10,000, provided that the net charge of the anionic polymer is negative.

With respect to the fluid, in an embodiment, a composition includes the fluid comprising produced water, flowback water, or a combination thereof, with the plurality of polyvalent metal cations being present in the fluid; a precipitation composition including the precipitating agent; and the flocculant or coagulant. Here, the flocculant includes the anionic polymer, and the precipitating agent comprises the polyvalent anion.

The precipitating agent is present in the precipitation composition in an amount from 0.5 wt % to 30 wt %, specifically 1 wt % to 30 wt %, and more specifically 5 wt % to 25 wt %, based on a weight of the precipitation composition. Moreover, the polyvalent metal ions are present in the fluid in an amount from 5 parts per million (ppm) to 20,000 ppm (or higher) before contacting the flocculant or coagulant based on the volume of the fluid. After separating the aggregate from the fluid, the polyvalent metal ions are present in the fluid in an amount less than or equal to 1 ppm, specifically less than or equal to 500 parts per billion (ppb), and more specifically less than or equal to 10 ppb based on the volume of the fluid.

The flocculant or coagulant is present in an amount from 5 ppm to 20,000 ppm, specifically 5 ppm to 10,000 ppm, more specifically 5 ppm to 1,000 ppm, and even more specifically 5 ppm to 200 ppm, based on the volume of the fluid.

A molecular weight of the flocculant is from 20 kiloDaltons (kD) to 40 megaDaltons (MD) (or greater), specifically 500 kD to 30 MD, and more specifically greater than 1 MD. The anionic polymer is provided in the form of beads, a powder, an emulsion, and the like. Additionally, the flocculant has a viscosity from 5 milliPascal seconds (mPa·s) to 50 mPa·s, specifically from 10 mPa·s to 25 mPa·s at a concentration of 0.01 wt % of the flocculant in deionized water as determined with a rheometer at room temperature.

In an embodiment, the anionic polymer comprises an anionic functional group (e.g., an acid group) that is present in an amount from 15 mole percent (mol %) to 100 mol %, specifically 30 mol % to 100 mol %, and more specifically 50 mol % to 85 mol %, based on the number of moles of repeat units in the anionic polymer. According to an embodiment, the anionic polymer is wholly anionic.

Before disposing the precipitation composition in the environment, the precipitation composition has a pH from 1 to 10, specifically 4 to 9. During the process to remove the polyvalent metal ions from the fluid, the pH of the environment in which the fluid is disposed is adjusted to a pH from 5 to 10, specifically 6 to 10, and more specifically 8 to 10 after disposing the precipitation composition in the environment. The pH of the fluid is changed to selectively effect formation of precipitate particles of desired polyvalent metal ions from the fluid or to decrease the amount of the polyvalent metal ions in the fluid to a certain amount, e.g., below 500 ppm, specifically less than 100 ppm, more specifically below 10 ppm, and even more specifically below 1 ppm.

Although precipitation of the polyvalent metal ions occurs over a broad range, the temperature of the precipitation composition is from 15° C. to 200° C., specifically 20° C. to 100° C., and more specifically 0° C. to 80° C.

The aggregate is partitioned from the fluid due to density differences, and the denser material accumulates on the bottom of the environment, e.g., a container. In an embodiment, the aggregate is denser than the fluid and settles on the bottom of the environment with the fluid disposed on the top of the aggregate. In some embodiments, the fluid is denser than the aggregate and settles on the bottom of the environment with the aggregate disposed on the top of the fluid. In this manner, the fluid and aggregate form strata within the environment.

To increase the amount of aggregate formed or to decrease the time for aggregate formation, the flocculant or coagulant and the precipitate particles are mixed so that the precipitate particles are distributed uniformly among the flocculant or coagulant. Such mixing increases the relative kinetic motion and collision rate of the precipitate particles and the flocculant or coagulant in the container. Mixing includes static or dynamic mixing using elements such as contoured surfaces in the environment, nozzles to inject the components of the composition, fans, blades, impellers, blenders, bubblers, injectors, and the like.

In an embodiment, motion in the environment is decreased or eliminated so that the aggregate forms efficiently. Moreover, the environment is made to be still in order to increase the size or amount of the precipitate particles.

The environment is any number of places where the removal of polyvalent metal ions occurs using a process herein. Exemplary environments include a container, vessel, pond, tank, and the like. The environment is open so that a surface of the fluid is exposed, enclosed, isolated, and the like. Applying pressure to the environment or decreasing a pressure of headspace above the fluid is accomplished in an enclosed container. Such a container includes vents and piping or tube for delivery or removal of composition components thereto.

Upon formation of the aggregate, it can be separated from the fluid by filtering the aggregate from the fluid, centrifuging the aggregate and the fluid and collecting the fluid, skimming the aggregate from the fluid, or a combination thereof. Any number of ways to separate the aggregate from the fluid is used.

In an embodiment, after removal of the polyvalent metal ions by separation of the aggregate from the fluid, the fluid is processed for use as a hydraulic fracturing fluid, storage or disposal. Thus, the fluid is reclaimed after removal of the polyvalent metal ions. In processing the fluid for use as a hydraulic fracturing fluid, additives are added to the fluid. Thereafter, the resulting hydraulic fracturing fluid is injected downhole for fracturing.

The process herein for precipitate formation and removal of polyvalent metal ions from a fluid are further illustrated by the following non-limiting example.

### EXAMPLE

A 100 milliliter (mL) sample of produced water was placed in a glass vessel at room temperature. Aliquots of the sample were subjected to elemental analysis to determine the initial concentration of metal ions in the sample. The sample was stirred, and 8.25 mL of a solution containing 18 wt % of trisodium phosphate in deionized water was added to the sample. After formation of a precipitate, Spectrafloc 875 flocculant (an acrylamide/acrylate copolymer) was added until the sample contained 100 ppm of the flocculant. The precipitate was flocculated and allowed to settle. The resulting aggregated precipitate was removed from the sample by gravity filtration. The supernatant was subjected to elemental analysis, and the final metal ion concentrations in the supernatant were determined. The results of the analysis are shown in the following Table.

TABLE

Concentration of metal ions (ppm)

| | | After removal of |
|---|---|---|
| | Before | precipitated |
| Ion | Precipitation | aggregated |
| Ca | 14800 | 9830 |
| Mg | 2310 | 1180 |
| Sr | 718 | 506 |
| Ba | 4.15 | 2.19 |
| Zn | 2.32 | <1 |
| B | 8.46 | 2.78 |
| Zn | 2.32 | <1 |
| Al | 5.92 | <1 |
| SO₄²⁻ | 362 | 240 |

As shown in the Table, substantial reduction in the concentration of the metal ions (and also boron and sulfate) occurred due to precipitation and aggregation.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like.

As used herein, “a combination thereof” refers to a combination comprising at least one of the named constituents, components, compounds, or elements.

All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” It should further be noted that the terms “first,” “second,” “primary,” “secondary,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity). The conjunction “or” is used to link objects of a list or alternatives and is not disjunctive; rather the elements can be used separately or can be combined together under appropriate circumstances.

What is claimed is:

1. A process for removing polyvalent metal ions from a fluid, the process comprising:
disposing a precipitation composition comprising a precipitating agent in an environment;
contacting, with the precipitation composition, a fluid comprising a produced water, a flowback water, or a combination including one or more of the foregoing, a plurality of polyvalent metal cations being present in the fluid;
forming a plurality of precipitate particles comprising the polyvalent metal cations from the fluid and a polyvalent anion from the precipitating agent; and
contacting the precipitant particles with a flocculant, a coagulant, or a combination comprising at least one of the foregoing, to form an aggregate comprising the precipitate particles.

2. The method of claim 1, further comprising mixing the flocculant or the coagulant and the precipitate particles to distribute uniformly the precipitate particles among the flocculant or the coagulant.

3. The method of claim 1, further comprising partitioning the aggregate from the fluid.

4. The method of claim 1, further comprising separating the aggregate from the fluid by filtering the aggregate from the fluid, centrifuging the aggregate and the fluid and collecting the fluid, skimming the aggregate from the fluid, or a combination including one or more of the foregoing.

5. The process of claim 1, further comprising adjusting the pH from 6 to 8 after disposing the precipitation composition in the environment.

6. The method of claim 1, wherein the flocculant or the coagulant is added to the environment after formation of the precipitate particles.

7. The method of claim 1, wherein the precipitation composition further comprises the flocculant or the coagulant.

8. The process of claim 1, wherein the precipitation composition further comprises a solvent.

9. The method of claim 1, wherein the polyvalent anion comprises phosphate metaphosphate, hexametaphosphate, pyrophosphate, hydrogen phosphate, gylcerylphophosphate, phophite, hydrogen phosphite, phosphonate, sulfate, sulfite, thiosulfate, carbonate, citrate, oxalate, adipate, fumarate, glutamate, malate, malonate, tatrate, or a combination including one or more of the foregoing.

10. The method of claim 1, wherein the polyvalent metal cations comprise aluminum, antimony, arsenic, barium, cadmium, calcium, chromium, cobalt, copper, gallium, germanium, hafnium, indium, iron, lanthanum, lead, magnesium, manganese, mercury, molybdenum, nickel, niobium, radium, selenium, silicon, silver, strontium, sulfur, tantalum, tellurium, thallium, tin, titanium, tungsten, vanadium, zinc, zirconium, or a combination including one or more of the foregoing.

11. The method of claim 1, wherein the flocculant comprises an anionic polymer.

12. The process of claim 1, wherein the precipitating agent is present in the precipitation composition in an amount from 1 wt % to 30 wt %, based on a weight of the precipitation composition.

13. The process of claim 1, wherein the flocculant or the coagulant is present in an amount from 5 ppm to 20,000 ppm, based on the volume of the fluid.

14. The process of claim 1, wherein the polyvalent metal ions are present in the fluid in an amount from 10 ppm to 20,000 ppm before contacting the flocculant or the coagulant, and
the polyvalent metal ions are present in the fluid in an amount less than or equal to 1 ppm after separating the aggregate from the fluid.

15. The process of claim 1, wherein a molecular weight of the flocculant is from 20,000 Daltons to 30,000,000 Daltons.

16. The process of claim 11, wherein the anionic polymer comprises an acid group which is present in the anionic polymer in an amount from 30 mol % to 100 mol %, based on the number of moles of repeat units in the anionic polymer.

17. The process of claim 1, wherein a temperature of the precipitation composition is from 15° C. to 200° C.

18. A composition comprising:
a fluid comprising produced water, flowback water, or a combination including one or more of the foregoing, a plurality of polyvalent metal cations being present in the fluid;
a precipitation composition comprising a precipitating agent; and
a flocculant, a coagulant, or a combination comprising at least one of the foregoing.

19. The composition of claim 18, wherein the flocculant comprises an anionic polymer.

20. The composition of claim 18, wherein the precipitating agent comprises a polyvalent anion.
